(19) United States
(12) Patent Application Publication
(10) Pub. No.: US 2012/0084412 A1
(43) Pub. Date: Apr. 5, 2012

(54) CONFIGURATION REPORTING

(75) Inventors: Steven P. Burns, Redmond, WA (US); Karthic N. Sivathanupillai, Redmond, WA (US); Rajive Kumar, Sammamish, WA (US)

(73) Assignee: Microsoft Corporation, Redmond, WA (US)

(21) Appl. No.: 12/896,928

(22) Filed: Oct. 4, 2010

(51) Int. Cl. G06F 15/173; G06F 15/177

(52) U.S. Cl. 709/221; 709/223

(57) ABSTRACT

A method includes transmitting a configuration policy from a policy service to one or more managed computing devices. The configuration policy includes values of each of a plurality of configuration parameters and identifies a subset of configuration parameters to be reported to the policy service. The method also includes receiving report data at the policy service from at least one of the managed computing devices. The report data includes results of processing the configuration policy.

### BACKGROUND

Computer networks at enterprises are often managed by system administrators. Typically, each workstation in the network is equipped with a software deployment. The system administrator may select programs and documents that make up the software deployment. To verify the status of the software deployment at each workstation, the system administrator may request a status update from each workstation. However, as more workstations are added to the network, deployment verification may become a time-consuming task for the system administrator.

### SUMMARY

Systems and methods of configuration reporting are disclosed. A policy service may receive configuration metadata from a software developer. The configuration metadata may include information about configurable parameters of hardware and software products that can be deployed to managed computing devices. A system administrator may define desired (e.g., recommended) or required values and constraints for the parameters. The policy service may transmit a configuration policy that reflects the desired values to the managed computing devices. A particular configuration policy may be transmitted to one or more managed computing devices, and each managed computing device may receive one or more configuration policies. Each managed computing device may execute a policy agent that retrieves configuration policies from the policy service and processes the configuration policies. The policy agent also transmits report data that includes the results of processing the configuration policy to the policy service. For example, the configuration policy may identify a subset of configuration parameters to be reported back to the policy service, and the report data from each managed computing device may include values of the subset of configuration parameters at that particular managed computing device. The policy service may aggregate the report data received from various managed computing devices and may present configuration status reports to the system administrator. Thus, managed computing devices may receive a configuration policy identifying a desired configuration and may report back to the policy service the status of their individual configurations with respect to the desired configuration.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of reporting configuration information to a policy service;

FIG. 2 is a diagram to illustrate a particular embodiment of configuration metadata that may be used by the system of FIG. 1;

FIG. 3 is a diagram to illustrate a particular embodiment of a configuration policy that may be used by the system of FIG. 1;

FIG. 4 is a diagram to illustrate another particular embodiment of a system of reporting configuration information to a policy service;

FIG. 5 is a flow diagram to illustrate a particular embodiment of a method of operation at a policy service;

FIG. 6 is a flow diagram to illustrate a particular embodiment of a method of operation at a policy agent of a managed computing device; and

FIG. 7 is a block diagram of a computing environment including a computing device operable to support embodiments of computer-implemented methods, computer program products, and system components as illustrated in FIGS. 1-6.

### DETAILED DESCRIPTION

In a particular embodiment, a method includes transmitting a configuration policy from a policy service to a managed computing device. The configuration policy includes values of each of a plurality of configuration parameters. The configuration policy also identifies a subset of configuration parameters to be reported to the policy service. The method also includes receiving report data at the policy service from the managed computing device, where the report data includes results of processing the configuration policy at the managed computing device.

In another particular embodiment, a computer-readable medium includes instructions that, when executed by a computer, cause the computer to receive a configuration policy from a policy service at a policy agent of a managed computing device. The configuration policy includes values and constraints of each of a plurality of configuration parameters and identifies a subset of the configuration parameters to be reported to the policy service. The instructions are also executable to cause the computer to process the configuration policy and to transmit report data from the policy agent to the policy service. The report data includes second values of each of the subset of configuration parameters, where the second values are determined at the managed computing device after processing the configuration policy.

In another particular embodiment, a computer system includes a processor and a policy service executable by the processor. The policy service is executable to receive configuration metadata including information associated with a plurality of configuration parameters. The policy service is also executable to generate an interface operable to receive desired values of the plurality of configuration parameters and to receive the desired values via the interface. The policy service is further executable to transmit a configuration policy to a plurality of managed computing devices, where the configuration policy includes the desired values and identifies a subset of configuration parameters to be reported back to the policy service. The policy service is executable to receive report data from the plurality of managed computing devices. The report data received from a particular managed computing device includes results of processing the configuration policy at the particular managed computing device.

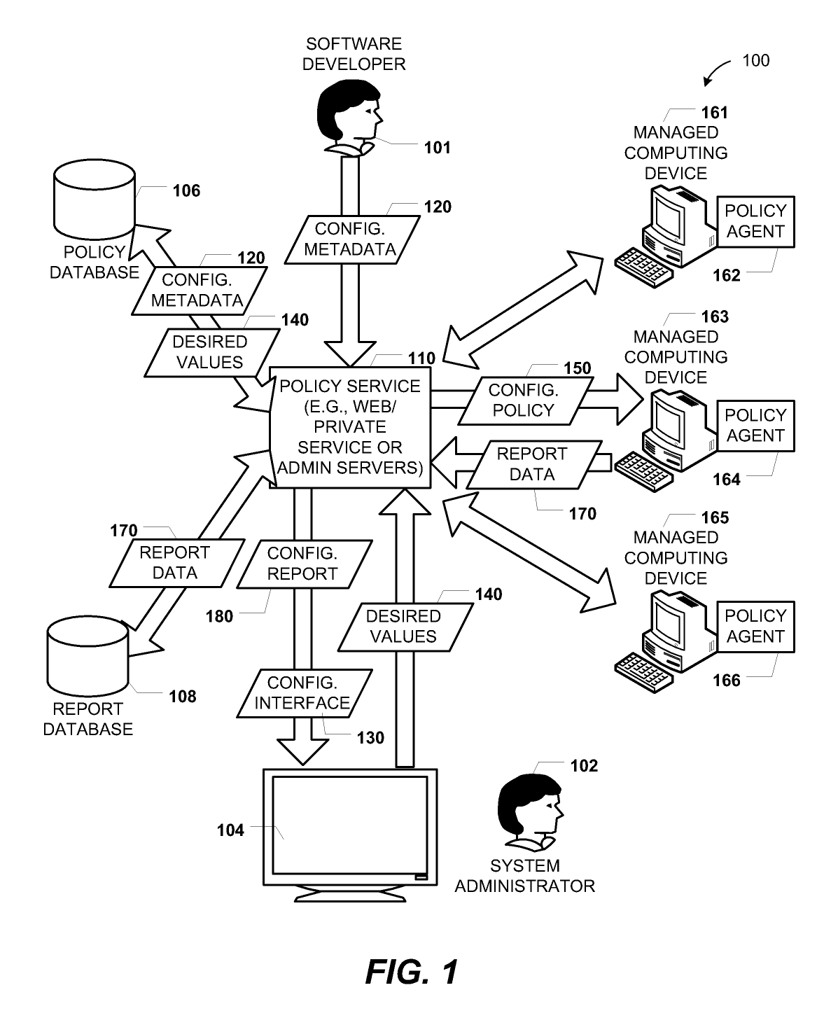

FIG. 1 is a diagram to illustrate a particular embodiment of a system 100 of reporting configuration information. The system 100 includes a policy service 110 communicatively coupled to a plurality of managed computing devices (e.g., illustrative managed computing devices 161, 163, and 165). The policy service 110 may also be coupled to a policy database 106 and to a report database 108. Generally, the system 100 may enable the policy service 110 to transmit configuration information to the managed computing devices 161, 163, 165. Further, the system 100 may enable the managed computing devices 161, 163, and 165 to transmit results of processing configuration policies to the policy service 110.

In a particular embodiment, the policy service 110 is implemented as a web service that is accessible to the managed computing devices 161, 163, and 165 via the Internet (e.g., as a “cloud-hosted” service). Alternately, the policy service 110 may be a service available to the managed computing devices 161, 163, and 165 via a private network. In yet another embodiment, the policy service 110 may be executed at one or more administration servers (e.g., physical or logical servers) that are part of a network that is accessible to the managed computing devices 161, 163, and 165 (e.g., as an “on-premise” software product available via a private network, such as a corporate network).

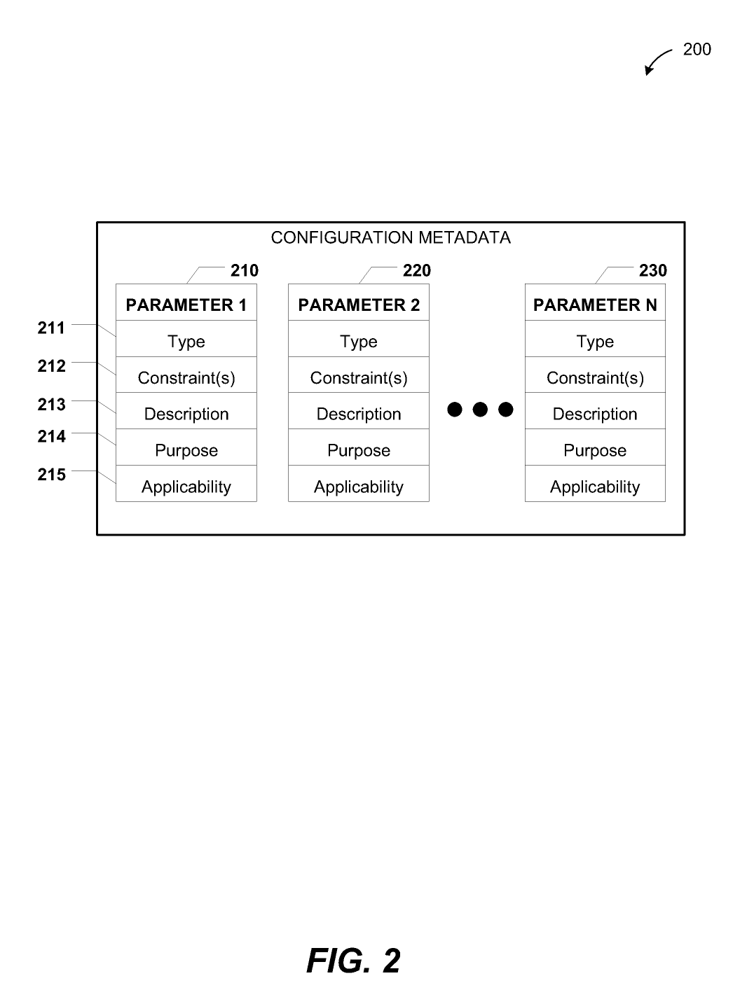

The policy service 110 may be configured to receive configuration metadata 120 that describes one or more configuration parameters. Configuration parameters may include, but are not limited to, hardware and software settings at one or more of the managed computing devices 161, 163, and 165. For example, the configuration metadata may include types, descriptions, and constraints (e.g., upper and lower bounds) of the configuration parameters. In a particular embodiment, the configuration metadata 120 may be provided by a user (e.g., a software developer 101). For example, the software developer 101 may provide configuration metadata associated with a particular software product that is developed by the software developer 101 and that is deployed (e.g., installed) at the managed computing devices 161, 163, and 165. In a particular embodiment, the software developer 101 installs the configuration metadata at the policy service 110. The configuration metadata 120 is further described and illustrated with reference to FIG. 2.

The policy service 110 may also be configured to generate and transmit a configuration interface 130 to be displayed at a display device 104. The configuration interface 130 may be operable to receive desired values 140 of one or more configuration parameters (e.g., configuration parameters described by the configuration metadata 120). For example, a user (e.g., a system administrator 102) may interact with the configuration interface 130 to provide the desired values 140. In a particular embodiment, the policy service 110 stores the configuration metadata 120 and the desired values 140 at a policy database 106. The policy database 106 and the policy service 110 may be located at the same computing device (e.g., server) or may be located remote to each other. In a particular embodiment, storing the configuration metadata 120 at the policy database 106 includes generating lookup tables that correlate the configuration metadata 120 with the desired values 140.

The policy service 110 may further be configured to generate and transmit a configuration policy 150 to the managed computing devices 161, 163, and 165. The configuration policy 150 may be deployed using a “pull” model (e.g., transmitted to one or more managed computing devices in response to a request from the particular managed computing device) or a “push” model (e.g., transmitted to one or more managed computing devices at the discretion of the policy service 110). In a particular embodiment, the configuration policy 150 includes or identifies the desired values 140 of the configuration parameters provided by the system administrator 102. The configuration policy 150 may also include constraints (e.g., high and low bounds) for the configuration parameters. For example, the desired value of a particular configuration parameter may be “5”, and a constraint for the configuration parameter may be “1<value<10.” In a particular embodiment, the configuration policy 150 identifies a subset of configuration parameters to be reported by the managed computing devices 161, 163, and 165 as report data 170 to the policy service 110. For example, the configuration policy 150 may include desired values for three parameters “A,” “B,” and “C.” For example, the parameters may represent a screensaver timeout, a screensaver name, and whether or not a user is required to login after deactivating the screensaver. The configuration policy 150 may indicate that the managed computing devices 161, 163, and 165 should report the values of “A” and “C” (e.g., the screensaver timeout and whether or not users will be required to login) back to the policy service 110. In a particular embodiment, the report data 170 also includes the original desired values 140 from the configuration policy 150. For example, including the desired values 140 in the report data 170 may enable the policy service 110 to determine whether the configuration policy 150 that was processed at the managed computing device is outdated (e.g., because the system administrator 102 has recently provided new desired values).

The policy service 110 may receive report data 170 from the managed computing devices 161, 163, and 165. The report data 170 may include the results of processing the configuration policy 150 at the managed computing devices 161, 163, and 165. The report data 170 from each particular managed computing device may be the same or may be different. The policy service 110 may store the report data 170 received from each of the managed computing devices (e.g., the managed computing devices 161, 163, and 165) at a report database 108 that may be located at the same server as the policy service 110 or may be located remote to the policy service 110. The policy service 110 may also generate a configuration report 180 based on the report data 170. For example, the configuration report 180 may provide the system administrator 102 with a configuration status of each of the managed computing devices 161, 163, and 165, and the configuration report 180 may include aggregated data, statistics information, or alerts.

The managed computing devices 161, 163, and 165 may include desktop computers, laptop computers, tablet computers, mobile phones, servers, other fixed or mobile computing devices, or any combination thereof. The managed computing devices 161, 163, and 165 may each include a policy agent (e.g., illustrative policy agents 162, 164, and 166, respectively). In a particular embodiment, the policy agents 162, 164, and 166 are deployed (e.g., installed) to the managed computing devices 161, 163, and 165 by the policy service 110. The policy agents 162, 164, and 166 include software that is executable to process configuration policies received from the policy service 110. The policy agents 162, 164, and 166 also include software that is executable to transmit results of processing the configuration policies to the policy service 110. Processing a configuration policy may include determining that a particular configuration parameter is non-compliant with the configuration policy and updating the configuration parameter to comply with the configuration policy. In a particular embodiment, a policy agent may mediate between multiple configuration policies. For example, a first configuration policy may constrain the value of the parameter “A” to between 1 and 10, and a second configuration policy may constrain the value of the parameter “A” to between 8 and 12. The policy agent may set the value of the parameter “A” to a value compliant with both policies (e.g., 9).

The report data 170 transmitted by a policy agent to the policy service 110 may include configuration parameter values that are determined at the managed computing device associated with the policy agent after processing of the configuration policy 150. For example, at a time after processing the configuration policy 150, the policy agents 162, 164, and 166 may query the managed computing devices 161, 163, and 165 for the values of the configuration parameters. Alternately, the policy agents 162, 164, and 166 may measure the values of certain configuration parameters (e.g., by executing tests or evaluating metrics at the managed computing devices 162, 164, and 166) The report data 170 may include the values of those configuration parameters that the configuration policy 150 identified to be reported back to the policy service 110.

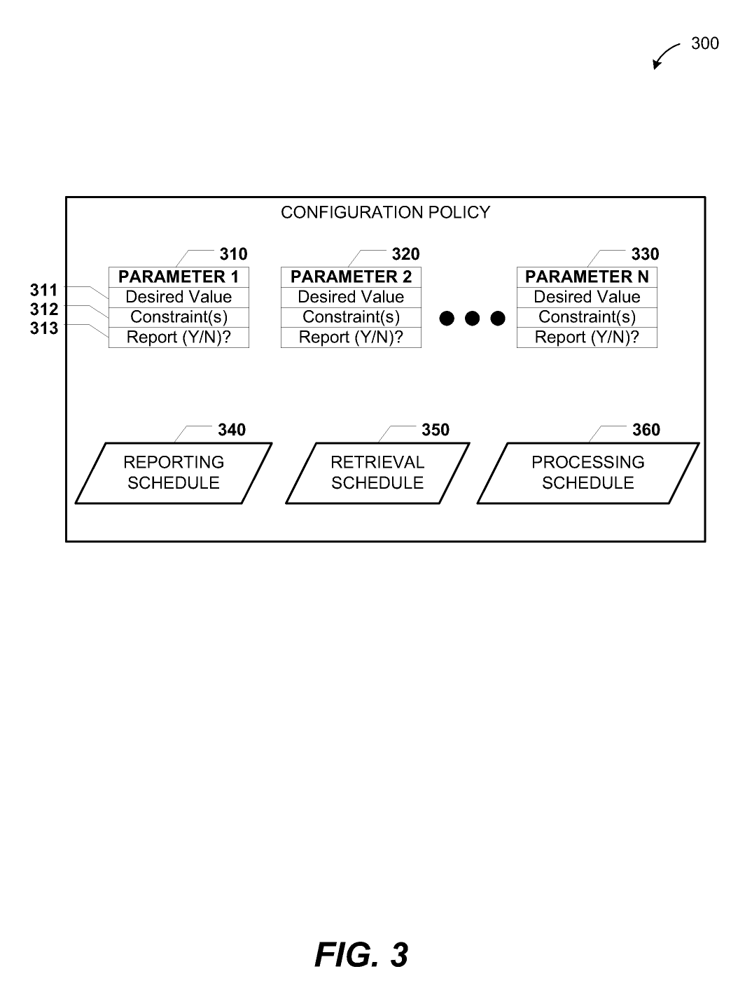

In a particular embodiment, the configuration policy 150 further includes one or more schedules for the policy agents 162, 164, and 166. For example, the configuration policy 150 may include a reporting schedule indicating when or how often policy agents transmit report data to the policy service 110. The configuration policy 150 may also include a retrieval schedule that indicates when or how often policy agents retrieve information (e.g., the configuration policy 150) from the policy service 110. The configuration policy 150 may further include a processing schedule indicating when or how often policy agents are to process previously retrieved and stored configuration policies. Illustrative configuration policies are further described with reference to FIG. 3.

It should be noted that although FIG. 1 depicts three managed computing devices 161, 163, and 165, more than three (or less than three) managed computing devices may be supported in the system 100. It should also be noted that the policy service 110 need not transmit identical configuration policies to each managed computing device. The policy service 110 may generate device-specific policies or group-specific policies (e.g., a policy deployed to each managed computing device within a particular group of computing devices). For example, each managed computing device in a particular enterprise department may be configured according to a departmental configuration policy. Managed computing devices may also be subject to multiple configuration policies. When a particular managed computing device is subject to multiple configuration policies, the policy agent at the particular managed computing device may rationalize the configuration policies, including collectively mediating constraints defined by the configuration policies. It should further be noted that communication of the configuration policy 150 and the report data 170 may be carried out using security mechanisms such as private networks, encryption, trust certificates, or any combination thereof.

In operation, the policy service 110 may receive the configuration metadata 120 (e.g., represented in accordance with an XML schema) from the software developer 101 and may generate the configuration interface 130 based on the configuration metadata 120. The system administrator 102 may use the configuration interface 130 to define the desired values 140 for certain configuration parameters. The system administrator 102 may also identify a subset of configuration parameters to be reported back to the policy service 110. Alternately, or in addition, the subset of configuration parameters to be reported back to the policy service 110 may be identified by the software developer 101 in the configuration metadata 120. The policy service 110 may generate the configuration policy 150 (e.g., represented in accordance with an XML schema), where the configuration policy 150 includes or identifies the desired values 140 and the subset of parameters to be reported to the policy service 110.

As an illustrative example, the policy agent 164 at the managed computing device 163 may retrieve the configuration policy 150 from the policy service (e.g., in accordance with a retrieval schedule provided in a previous configuration policy) and may store the retrieved configuration policy 150 at the managed computing device 163. The policy agent 164 may subsequently process the stored configuration policy (e.g., in accordance with a processing schedule included in the configuration policy 150). Processing the configuration policy 150 may include evaluating configuration parameters at the managed computing device 163 for compliance with the configuration policy 150. Processing the configuration policy 150 may also include determining that a particular configuration parameter is non-compliant with the configuration policy 150 and updating the particular configuration parameter in order to comply with the configuration policy 150.

The policy agent 164 may transmit the report data 170 to the policy service 110 (e.g., in accordance with a reporting schedule included in the configuration policy 150), where the report data 170 includes results of processing the configuration policy 150. For example, the report data 170 may include the value 9 for the parameter “A.” In a particular embodiment, the report data 170 is represented in accordance with an XML schema. The policy service 110 may generate the configuration report 180 for the system administrator 102, where the configuration report 180 indicates that the parameter “A” has a value of 9 at the managed computing device 163. Similar operations may also occur with respect to the other managed computing devices 161, 165 and policy agents 162, 166.

It will be appreciated that in the system 100 of FIG. 1, managed computing devices may “push” (e.g., automatically report) the results of processing configuration policies to a central aggregator and collector (e.g., the policy service 110). The system 100 of FIG. 1 may thus be more scalable than existing systems where a system administrator manually requests raw configuration data from each computing device and processes all of the raw configuration data at a central server. The system 100 of FIG. 1 may thus efficiently distribute processing of configuration information across multiple managed computing devices instead of at a single central server.

FIG. 2 is a diagram to illustrate a particular embodiment of configuration metadata 200. In an illustrative embodiment, the configuration metadata 200 is the configuration metadata 120 of FIG. 1.

The configuration metadata 200 may include information associated with each of a plurality of configuration parameters. For example, in the particular embodiment illustrated in FIG. 2, the configuration metadata 200 includes information associated with a first parameter 210, a second parameter 220, and an Nth parameter 230. For each configuration parameter 210, 220, 230, the configuration metadata 200 may include one or more of a type 211 of the configuration parameter, a constraint(s) 212 applicable to the configuration parameter, a description 213 of the configuration parameter, a purpose 214 of the configuration parameter, and an applicability 215 of the configuration parameter.

For example, the configuration metadata 200 may be associated with a screensaver application at a managed computing device (e.g., one of the managed computing devices 161, 163, 165 of FIG. 1) and may include information regarding a “screensaver timeout” configuration parameter. In this example, the type 211 of the parameter may be “minutes,” an applicable constraint 212 may be “5 minutes<value<10 minutes,” the description 213 of the parameter may be “This parameter dictates how long the screen must be inactive before the screensaver activates,” the purpose 214 of the parameter may be “This parameter will enable administrators to balance between avoiding screen burn-in and allowing users a reasonable time to leave a workstation inactive before the screensaver starts,” and the applicability 215 of the parameter may be “Applies to all computers on the network.”

The configuration metadata 200 may be provided by a software developer along with a software application. For example, in the example above, the configuration metadata 200 may be provided by a developer of the screensaver application or by a developer of the operating system that executes the screensaver application. Alternately, the configuration metadata 200 may be automatically generated based on the software application. For example, the configuration metadata 200 may be automatically generated during compilation of source code of the screensaver application.

It will be appreciated that the configuration metadata 200 may encapsulate information associated with configuration parameters, where the information may be used by system administrators to determine which configuration policies are to be deployed to particular managed computing devices. It will also be appreciated that the configuration metadata 200 may provide a vehicle for software developers to define “default,” “recommended,” or “required” configuration parameter values or constraints. System administrators may selectively overwrite those values or constraints as desired.

FIG. 3 is a diagram to illustrate a particular embodiment of a configuration policy 300. In an illustrative embodiment, the configuration policy 300 is the configuration policy 150 of FIG. 1.

The configuration policy 300 may include information associated with each of a plurality of configuration parameters. For example, in the particular embodiment illustrated in FIG. 3, the configuration policy 300 includes information associated with a first parameter 310, a second parameter 320, and an Nth parameter 330. For each configuration parameter 310, 320, 330, the configuration policy 300 may include a desired value 311 of the configuration parameter, a constraint(s) 312 applicable to the configuration parameter, and an indicator 313 of whether or not a managed computing device that processes the configuration policy 300 should report data for the configuration parameter back to a policy service (e.g., the policy service 110 of FIG. 1).

The configuration policy 300 may also include one or more schedules. For example, the configuration policy 300 may include a reporting schedule 340, a retrieval schedule 350, and a processing schedule 360. The reporting schedule 340 may indicate when or how often a managed computing device transmits configuration report data to the policy service. The retrieval scheduling 350 may indicate when or how often configuration policies are to be retrieved from the policy service 110 by the managed computing device. The processing schedule 360 may indicate when or how often the managed computing device processes a previously received or stored configuration policy.

Each of the reporting schedule 340, the retrieval schedule 350, and the processing schedule 360 may include a periodic schedule (e.g., “every 6 hours”), a specific time schedule (e.g. “8:00 am and 5:00 pm”), or some other schedule (e.g., “each time a configuration parameter changes at the managed computing device” or “each time a user logs in or logs off at the managed computing device”). A policy agent at a managed computing device may automatically report, retrieve, and process data in accordance with the schedules 340, 350, and 360.

It will be appreciated that the configuration policy 300 may thus provide a data structure that system administrators may use to encapsulate and deploy configuration information. It should be noted that any number of configuration policies may be provided to any number of managed computing devices, and that configuration policies may differ with respect to included parameters and schedules. Configuration policies may also be defined by multiple sources (e.g., multiple system administrators), and conflicts between different configuration policies may be resolved at the managed computing devices.

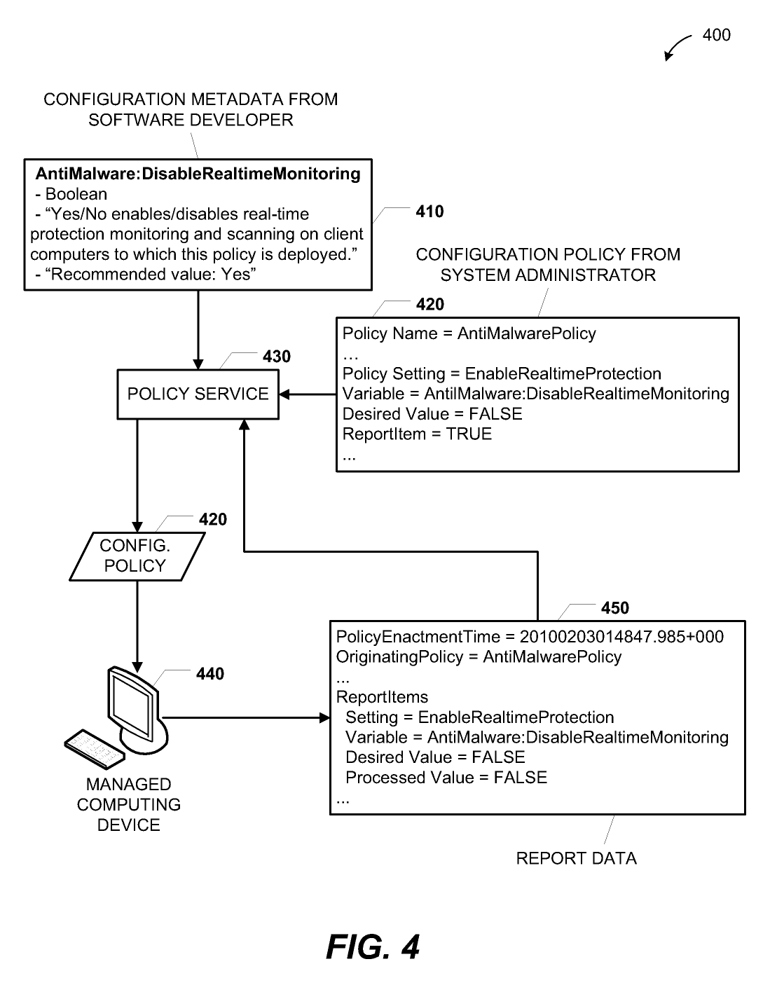

FIG. 4 is a diagram to illustrate another particular embodiment of a system 400 of reporting configuration information. The system 400 includes a policy service 430 communicatively coupled to a managed computing device 440. In an illustrative embodiment, the policy service 430 is the policy service 110 of FIG. 1, and the managed computing device 440 is one of the managed computing devices 161, 163, 165 of FIG. 1.

The policy service 430 may receive configuration metadata 410 from a software developer. In an illustrative embodiment, the configuration metadata 410 is the configuration metadata 120 of FIG. 1 or the configuration metadata 200 of FIG. 2. For example, the configuration metadata 410 may include information associated with a “DisableRealtimeMonitoring” configuration parameter for a software package “AntiMalware,” as illustrated in FIG. 4. The configuration parameter may have a type “Boolean,” a description/purpose “Yes/No enables/disables real-time protection monitoring and scanning on client computers to which this policy is deployed.” and a recommended value of “Yes.”

In a particular embodiment, the configuration metadata 410 is encoded according to an extensible markup language (XML). For example, the configuration metadata 410 may be encoded into the following XML code, which also includes information for additional configuration parameters “AntiMalware:ScanParameters” and “AntiMalware:ExcludedPaths.”

```
<CLASS NAME=“AntiMalware”>
  <PROPERTY NAME=“ AntiMalware:DisableRealtimeMonitoring”
    CLASSORIGIN=“AntiMalware” TYPE=“boolean”>
  <QUALIFIER NAME=“CIMTYPE” TYPE=“string”
  TOINSTANCE=“true”>
    <VALUE>boolean</VALUE>
  </QUALIFIER>
  <QUALIFIER NAME=“write” TYPE=“boolean”
  TOSUBCLASS=“false”>
    <VALUE>TRUE</VALUE>
  </QUALIFIER>
  </PROPERTY>
  <PROPERTY NAME=“AntiMalware:ScanParameters”
    CLASSORIGIN=“AntiMalware” TYPE=“uint32”>
  <QUALIFIER NAME=“CIMTYPE” TYPE=“string”
  TOINSTANCE=“true”>
    <VALUE>uint32</VALUE>
  </QUALIFIER>
  <QUALIFIER NAME=“ValueMap” TYPE=“string”
  TOSUBCLASS=“false”>
    <VALUE.ARRAY>
    <VALUE>QuickScan</VALUE>
    <VALUE>FullSystemScan</VALUE>
    </VALUE.ARRAY>
  </QUALIFIER>
  <QUALIFIER NAME=“Values” TYPE=“sint32”
  TOSUBCLASS=“false”>
    <VALUE.ARRAY>
    <VALUE>1</VALUE>
    <VALUE>2</VALUE>
    </VALUE.ARRAY>
  </QUALIFIER>
  <QUALIFIER NAME=“write” TYPE=“boolean”
  TOSUBCLASS=“false”>
    <VALUE>TRUE</VALUE>
  </QUALIFIER>
  </PROPERTY>
  <PROPERTY.ARRAY NAME=“ AntiMalware:ExcludedPaths”
    CLASSORIGIN=“AntiMalware” TYPE=“string”>
  <QUALIFIER NAME=“CIMTYPE” TYPE=“string”
  TOINSTANCE=“true”>
    <VALUE>string</VALUE>
  </QUALIFIER>
  <QUALIFIER NAME=“MAXLEN” TYPE=“sint32”
  TOSUBCLASS=“false”>
    <VALUE>260</VALUE>
  </QUALIFIER>
  <QUALIFIER NAME=“write” TYPE=“boolean”
  TOSUBCLASS=“false”>
    <VALUE>TRUE</VALUE>
  </QUALIFIER>
  </PROPERTY.ARRAY>
</CLASS>
```

The configuration metadata 410 may be associated with or include an XML annotation and an XML resource table that includes additional information for the configuration parameters:

```
<configurationPointAnnotations revision=“1.0” schemaVersion=“1.0”>
  <configurationPointNamespaces>
  <target namespace=“Policies.AntiMalware” prefix=“hp”/>
  <using namespace=“Policies.OS” prefix=“os”/>
  </configurationPointNamespaces>
  <resources minRequiredRevision=“1.0”/>
  <configurationPoints>
  <configurationPoint
    selector=“AntiMalware:DisableRealtimeMonitoring”
    descriptionRef=“AntiMalware:DisableRealtimeMonitoring”
    helpTextRef=“AntiMalware:DisableRealtimeMonitoring”
    displayNameRef=“AntiMalware:DisableRealtimeMonitoring”>
    <enumValues>
    <enumValue value=“true” valueLabelRef=“NO”/>
    <enumValue value=“false” valueLabelRef=“YES”/>
    </enumValues>
  </configurationPoint>
  <configurationPoint
    selector=“AntiMalware:ScanParameters”
    descriptionRef=“AntiMalware:ScanParameters”
    helpTextRef=“AntiMalware:ScanParameters”
    displayNameRef=“AntiMalware:ScanParameters”>
    <enumValues>
    <enumValue value=“1” valueLabelRef=“QUICKSCAN”/>
    <enumValue value=“2” valueLabelRef=“FULLSCAN”/>
    </enumValues>
  </configurationPoint>
  <configurationPoint
    selector=“AntiMalware:ExcludedPaths”
    descriptionRef=“AntiMalware:ExcludedPaths ”
    helpTextRef=“AntiMalware:ExcludedPaths ”
    displayNameRef=“AntiMalware:ExcludedPaths ”>
    <enumValues>
    <enumValue value=“1” valueLabelRef=“QUICKSCAN”/>
    <enumValue value=“2” valueLabelRef=“FULLSCAN”/>
    </enumValues>
  </configurationPoint>
  </configurationPoints>
</configurationPointAnnotations>
<configurationPointAnnotationResources revision=“1.0” schemaVersion=“1.0”>
  <resources>
  <displayNameTable>
    <string id=“AntiMalware:DisableRealtimeMonitoring”>Enable real-time
    protection:</string>
    <string id=“AntiMalware:ScanParameters”>Scan Type:</string>
    <string id=“AntiMalware:ExcludedPaths”>Files and folders to exclude when
    running a scan or using real-time protection</string>
  </displayNameTable>
  <descriptionTable>
    <string id=“AntiMalware:DisableRealtimeMonitoring”>This policy setting lets
    you enable monitoring and scanning of all files and applications that are loaded
    for use, and blocks any malicious files and applications before they can run on
    client computers.
    “Yes” enables real-time protection monitoring and scanning on client computers
      to which this policy is deployed.
    “No” disables real-time protection monitoring and scanning on client computers
      to which this policy is deployed.
    Recommended value: Yes</string>
    <string id=“AntiMalware:ScanParameters”>Scan Type</string>
    <string id=“ AntiMalware:ScanParameters:ResourceOnly”>These policy
    settings let you schedule a full system scan of all files and resources on the local
    hard disks of client computers. This detailed scan may take a while and affect
    computer performance (depending on the number of files and resources
    scanned). However, a full scan ensures that all files and resources are scanned.
    “Yes” schedules a full system scan on for the day and time that you specify on client
      computers to which this policy is deployed.
    “No” does not schedule a full system scan on client computers to which this
      policy is deployed.
    Recommended value: No</string>
    <string id=“AntiMalware:ExcludedPaths”>This policy setting lets you exclude
    specific files and folders when you run a scan or use real-time protection.
    Excluding some files and folders can help speed up the scan, but may leave the
    computer less protected.</string>
  </descriptionTable>
  <helpTextTable>
    <string id=“AntiMalware:DisableRealtimeMonitoring”></string>
    <string id=“AntiMalware:ScanParameters”></string>
    <string id=“AntiMalware:ExcludedPaths”></string>
  </helpTextTable>
  <enumValueLableTable>
    <string id=“QUICKSCAN”>QuickScan</string>
    <string id=“FULLSCAN”>FullSystemScan</string>
    <string id=“YES”>Yes</string>
    <string id=“NO”>No</string>
  </enumValueLableTable>
  </resources>
</configurationPointAnnotationResources>
```

The policy service 430 may generate a configuration policy 420 based on the configuration metadata 410 and parameter definitions received from a system administrator. The configuration policy 420 may be transmitted to the managed computing device 440. In an illustrative embodiment, the configuration policy 420 is the configuration policy 150 of FIG. 1 or the configuration policy 300 of FIG. 3. For example, the configuration policy 420 may indicate that a system administrator has specified that the desired value of the “DisableRealtimeMonitoring” parameter is “FALSE” (which corresponds to the recommended value of “Yes”) and that the “DisableRealtimeMonitoring” parameter should be reported back to the policy service 430 (e.g., by setting a “ReportItem” field for the parameter as “TRUE”).

In a particular embodiment, the configuration policy 420 is encoded according to an XML schema as follows:

```
<Policy xmlns=“PolicyPlatform/2009” Name=“AntiMalwarePolicy”
  SourceTemplateId=“ AgentSettingsPolicyTemplate”>
<Settings>
  <SettingId=“ EnableRealtimeProtection”>
  <RuleName=“ EnableRealtimeProtection/SettingRule”>
    <Goal Invariant=“$ruleTemplateVariable = false”>
    <Variables>
      <Variable Name=“ruleTemplateVariable”
      Selector=“DisableRealtimeMonitoring from AntiMalware”
      IsChangeable=“true” />
    </Variables>
    <Optimizations />
    </Goal>
    <Conditions />
  </Rule>
  <ReportItems>
    <ReportItem SettingId=“EnableRealtimeProtection”
    ReportItemId=“ReportItem”>
    <ConfigurationPropertyParameter
      PropertyId=“AntiMalware:DisableRealtimeMonitoring”>False
    </ConfigurationPropertyParameter>
    </ReportItem>
  </ReportItems>
  </Setting>
  <SettingId=“ExcludedPaths”>
  <Rule Name=“ExcludedPathsRule”>
    <Goal Invariant=“$paths.includesAll(Set{ ‘c:\users’, ‘c:\system’ })”>
    <Variables>
      <Variable Name=“paths”
      Selector=“ExcludedPaths from AntiMalware”
      IsChangeable=“true” />
    </Variables>
    <Optimizations />
    </Goal>
    <Conditions />
  </Rule>
  <ReportItems>
    <ReportItem SettingId=“ExcludedPaths” ReportItemId=“ReportItem”>
    <ConfigurationPropertyParameter
      PropertyId=“AntiMalware:ExcludedPaths”>
      <OrderedCollection>
      <sys:String xmlns:sys=“clr-namespace:System;
        assembly=corlib” Index=“0”>c:\users</sys:String>
      <sys:String xmlns:sys=“clr-namespace:System;
        assembly=corlib” Index=“1”>c:\system</sys:String>
      </OrderedCollection>
    </ConfigurationPropertyParameter>
    </ReportItem>
  </ReportItems>
  </Setting>
</Policy>
```

It will be appreciated that the above XML schema indicates that the parameters “DisableRealtimeMonitoring” and “ExcludedPaths” are ReportItems but the parameter “ScanParameters” is not a ReportItem. Thus, fewer than all of the configuration parameters may be selected as ReportItems to be reported back to the policy service 430, thereby enabling a system administrator to control the amount of bandwidth in a system that is used for reporting configuration data to a policy service.

The managed computing device 440 may process the configuration policy 420 and may transmit results of processing the configuration policy 420 (including the selected “ReportItems”) to the policy service 430. For example, the managed computing device 440 may transmit report data 450 to the policy service 430. In an illustrative embodiment, the report data 450 is the report data 170 of FIG. 1.

In a particular embodiment, the report data 450 is encoded according to an XML schema as follows:

```
<Event xmlns=“PolicyPlatform/2009/Reporting/1” ErrorNumber=“0”
Type=“6”>
  <PolicyReport enactmentTime=“20100203014847.985+000”
  enactmentDurationInSeconds=“1”
  enactedPoliciesCount=“3”>
  <Setting status=“0”>
    <OriginatingPolicies>
    <OriginatingPolicy displayName=“AntiMalware Policy”
      documentID=“612885E2-97B2-4BCD-8ACA-6F0512F77AB1”
      documentRevision=“1” />
    </OriginatingPolicies>
    <ReportParameters>
    <ReportItems xmlns=“PolicyPlatform/2009”>
      <ReportItem SettingId=“EnableRealtimeProtection”
      ReportItemId=“ReportItem”>
      <ConfigurationPropertyParameter
        PropertyId=“ AntiMalware:DisableRealtimeMonitoring”>False
      </ConfigurationPropertyParameter>
      </ReportItem>
    </ReportItems>
    </ReportParameters>
  </Setting>
  <Setting status=“0”>
    <OriginatingPolicies>
    <OriginatingPolicy displayName=“AntiMalware Policy”
      documentID=“612885E2-97B2-4BCD-8ACA-6F0512F77AB1”
      documentRevision=“1” />
    </OriginatingPolicies>
    <ReportParameters>
    <ReportItems xmlns=“PolicyPlatform/2009”>
      <ReportItem SettingId=“ExcludedPaths”
      ReportItemId=“ReportItem”>
      <ConfigurationPropertyParameter
        PropertyId=“ AntiMalware:ExcludedPaths”>
        <OrderedCollection>
        <sys:String xmlns:sys=“clr-namespace:System;
          assembly=corlib” Index=“0”>c:\users</sys:String>
        <sys:String xmlns:sys=“clr-namespace:System;
          assembly=corlib” Index=“1”>c:\system</sys:String>
        </OrderedCollection>
      </ConfigurationPropertyParameter>
      </ReportItem>
    </ReportItems>
    </ReportParameters>
  </Setting>
  </PolicyReport>
</Event>
```

FIG. 4 thus depicts a particular embodiment of generating the configuration policy 420 based on configuration metadata 410, deploying the configuration policy 420 to the managed computing device 440, and receiving the report data 450 from the managed computing device 440. The system 400 of FIG. 4 may thus provide scalable reporting of configuration information to the policy service 430 with increased convenience for system administrators.

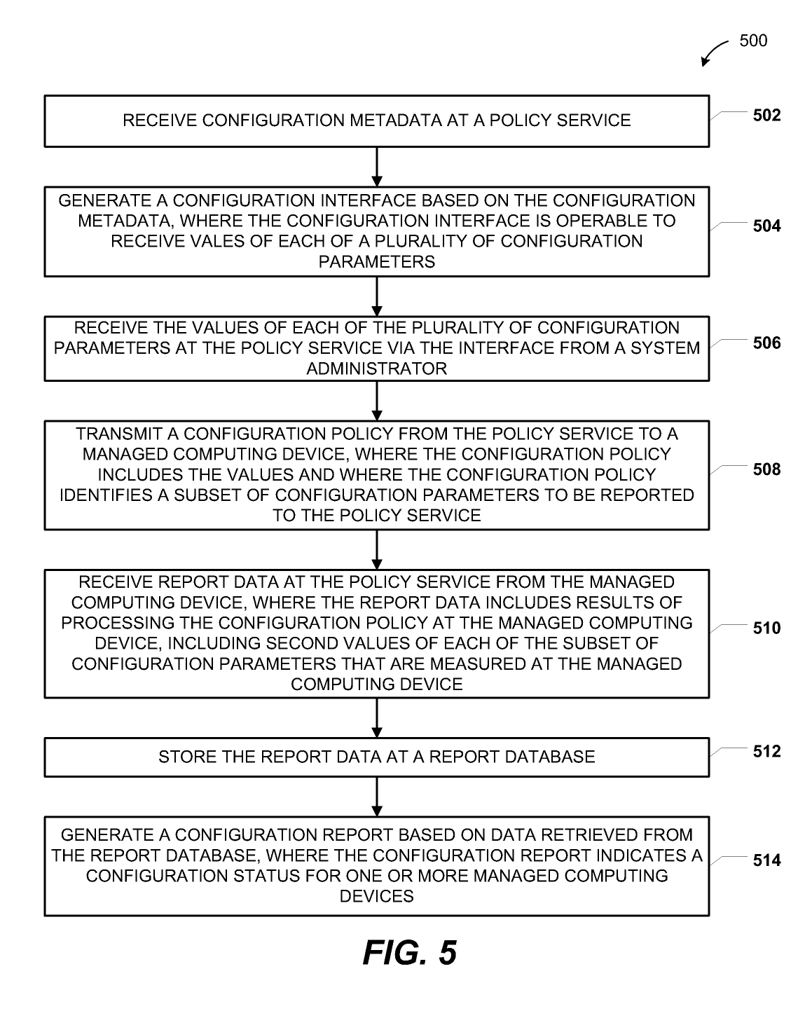

FIG. 5 is a flow diagram to illustrate a particular embodiment of a method 500 of operation of a policy service. In an illustrative embodiment, the method 500 may be performed by the policy service 110 of FIG. 1 or the policy service 430 of FIG. 4.

The method 500 includes receiving configuration metadata at a policy service, at 502. The configuration metadata may be received from a software developer or from some other source having knowledge of the configuration parameters in a system. For example, in FIG. 1, the policy service 110 may receive the configuration metadata 120. To illustrate, the configuration metadata may be the AntiMalware configuration metadata 410 of FIG. 4.

The method 500 also includes generating a configuration interface based on the configuration metadata, at 504. The configuration interface is operable to receive values of each of a plurality of configuration parameters. For example, in FIG. 1, the policy service 110 may generate the configuration interface 130.

The method 500 further includes receiving values of each of the plurality of configuration parameters at the policy service via the interface from a system administrator, at 506. For example, in FIG. 1, the policy service 110 may receive the desired values 140. To illustrate, the desired values may include the value “FALSE” for the configuration parameter “AntiMalware:DisableRealtimeMonitoring” described with reference to FIG. 4.

The method 500 includes transmitting a configuration policy from the policy service to a managed computing device, at 508. The configuration policy includes the values and identifies a subset of configuration parameters to be reported to the policy service. For example, in FIG. 1, the policy service may transmit the configuration policy 150 to the managed computing device 163. To illustrate, the configuration policy may be the AntiMalware policy 420 of FIG. 4, which includes the desired value “FALSE” for the configuration parameter “AntiMalware:DisableRealtimeProtection” and identifies the parameter as a “ReportItem” to be reported back to the policy service 430.

The method 500 includes receiving report data at the policy service from the managed computing device, at 510. The report data includes results of processing the configuration policy at the managed computing device. The results include second values of each of the subset of configuration parameters that are measured at the managed computing device. For example, in FIG. 1, the policy service 110 may receive the report data 170 from the managed computing device 163. To illustrate, the report data may be the AntiMalware report data 460 of FIG. 4, which includes the value of the configuration parameter “AntiMalware:DisableRealtimeProtection” at the managed computing device 440 after the AntiMalware policy 420 is processed.

In the embodiment illustrated, the method 500 also includes storing the report data at a report database, at 512, and generating a configuration report based on data retrieved from the report database, at 514. The configuration report indicates a configuration status for one or more managed computing devices. For example, in FIG. 1, the policy service 110 may store the report data 170 at the report database 108 and may generate the configuration report 180.

The method 500 of FIG. 5 may thus enable system administrators to define configuration policies for managed computing devices. The method 500 of FIG. 5 may also enable system administrators to view the configuration status of each managed computing device without requiring the system administrator to retrieve and analyze raw configuration data from each managed computing device.

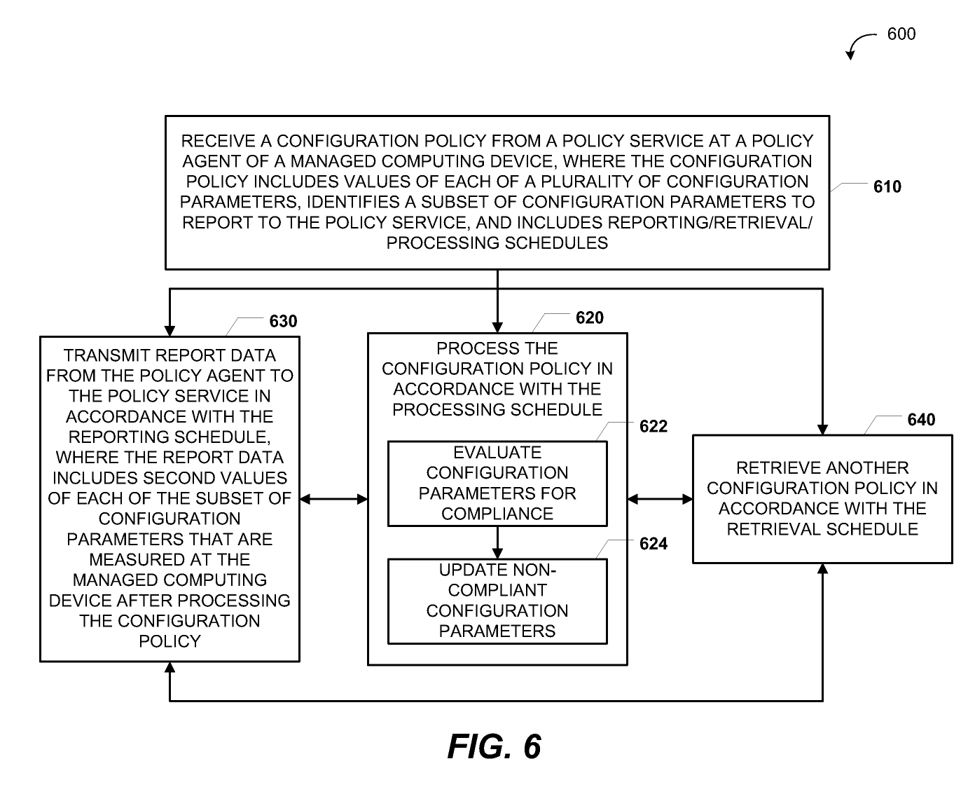

FIG. 6 is a flow diagram to illustrate a particular embodiment of a method 600 of operation of a policy agent of a managed computing device. In an illustrative embodiment, the method 600 may be performed at the policy agent 162, 164, or 166 of FIG. 1 or at the managed computing device 440 of FIG. 4.

The method 600 includes receiving a configuration policy from a policy service at a policy agent of a managed computing device, at 610. The configuration policy includes values of each of a plurality of configuration parameters. The configuration policy also identifies a subset of configuration parameters to be reported to the policy service. The configuration policy further includes a reporting schedule, a retrieval schedule, and a processing schedule. For example, in FIG. 1, the policy agent 164 may receive the configuration policy 150. To illustrate, the configuration policy 150 may include the AntiMalware policy 420 of FIG. 4 and may include the reporting schedule 340, the retrieval schedule 350, and the processing schedule 360 of FIG. 3.

The method 600 may also include one or more of processing the configuration policies in accordance with the processing schedule, at 620, transmitting report data in accordance with the reporting schedule, at 630, and retrieving other configuration policies in accordance with the retrieval schedule, at 640. The number of times and order in which the actions 620, 630, and 640 are performed may depend on the particular details of the processing schedule, the reporting schedule, and the retrieval schedule, respectively. For example, in FIG. 1, the managed computing devices 161, 163, and 165 may transmit the report data 170 to the policy service 110 at different times to avoid overloading the policy service 110.

Processing the configuration policy, at 620, may include evaluating configuration parameters for compliance with the configuration policy, at 622. For example, in FIG. 1, the policy agent 164 may evaluate configuration parameters at the managed computing device 163 for compliance with the configuration policy 150. To illustrate, a policy agent at the managed computing device 440 of FIG. 4 may evaluate the “AntiMalware:DisableRealtimeProtection” parameter for compliance with the AntiMalware policy 420. Processing the configuration policy may also include updating non-compliant configuration parameters, at 624. To illustrate, if the “AntiMalware:DisableRealtimeProtection” parameter at the managed computing device 440 is “TRUE” (i.e., non-compliant with the desired value of “FALSE”), the parameter may be set to “FALSE.” Alternately, an alert may be generated to notify a system administrator of the non-compliance (e.g., via the report)

The report data that is transmitted, at 630, may include second values of each of the subset of configuration parameters that are measured at the managed computing device after processing the configuration policy. For example, in FIG. 1, the policy agent 164 may transmit the report data 170 to the policy service 110. To illustrate, the report data may be the AntiMalware report data 450 of FIG. 4, which indicates that the value of the “AntiMalware:DisableRealtimeProtection” configuration parameter is “FALSE” after processing the AntiMalware policy 420.

It should be noted that the other configuration policies that are retrieved, at 640, may include updated versions of the originally received configuration policy, versions of unrelated configuration policies (e.g., non-malware policies with respect to FIG. 4), or any combination thereof.

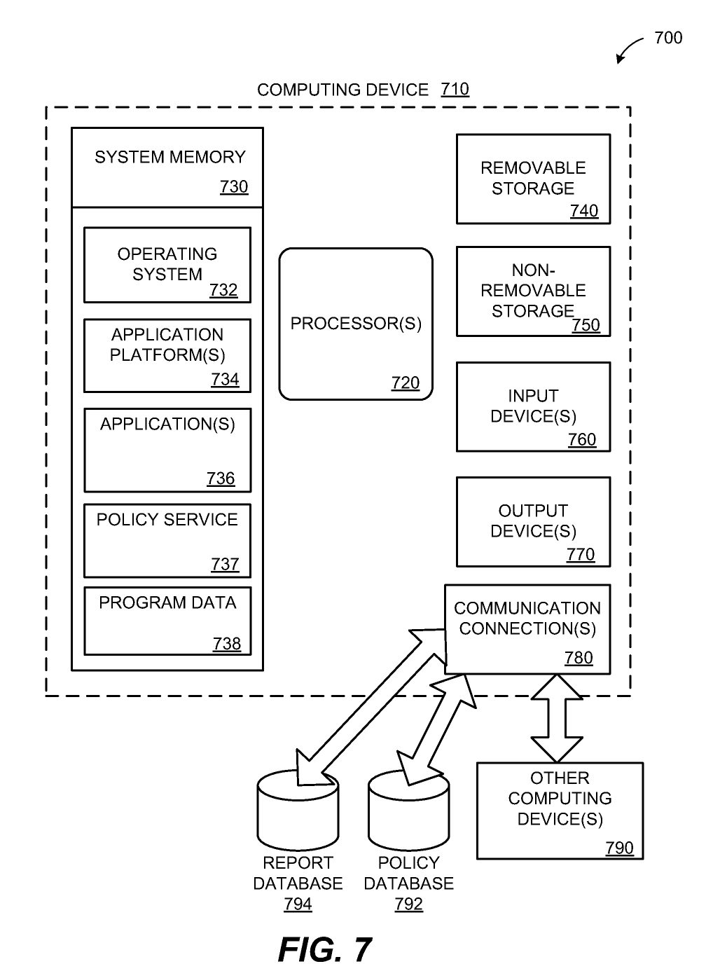

FIG. 7 shows a block diagram of a computing environment 700 including a computing device 710 operable to support embodiments of computer-implemented methods, computer program products, and system components according to the present disclosure. For example, the computing device 710 or components thereof may include, implement, or be included as a component of the policy database 106 of FIG. 1, the report database 108 of FIG. 1, the policy service 110 of FIG. 1, the managed computing devices 161, 163 and 165 of FIG. 1, the policy agents 162, 164, and 166 of FIG. 1, the policy service 430 of FIG. 4, the managed computing device 440 of FIG. 4, or portions thereof.

The computing device 710 includes at least one processor 720 and a system memory 730. For example, the computing device 710 may be a desktop computer, a laptop computer, a tablet computer, a mobile phone, a server, or any other fixed or mobile computing device. Depending on the configuration and type of computing device, the system memory 730 may be volatile (such as random access memory or “RAM”), non-volatile (such as read-only memory or “ROM,” flash memory, and similar memory devices that maintain stored data even when power is not provided), non-transitory, some combination of the three, or some other memory. The system memory 730 may include an operating system 732, one or more application platforms 734, one or more applications 736, and program data 738. In the embodiment illustrated, the system memory 730 includes a policy service 737. In an illustrative embodiment, the policy service 737 may be the policy service 110 of FIG. 1 or the policy service 430 of FIG. 4. In another illustrative embodiment, the program data 738 may include the configuration interface 130 of FIG. 1.

The computing device 710 may also have additional features or functionality. For example, the computing device 710 may also include removable and/or non-removable additional data storage devices such as magnetic disks, optical disks, tape, and standard-sized or flash memory cards. Such additional storage is illustrated in FIG. 7 by removable storage 740 and non-removable storage 750. Computer storage media may include volatile and/or non-volatile storage and removable and/or non-removable media implemented in any technology for storage of information such as computer-readable instructions, data structures, program components or other data. The system memory 730, the removable storage 740, and the non-removable storage 750 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 710. Any such computer storage media may be part of the computing device 710.

The computing device 710 may also have input device(s) 760, such as a keyboard, mouse, pen, voice input device, touch input device, etc. connected via one or more input interfaces. Output device(s) 770, such as a display, speakers, printer, etc. may also be included and connected via one or more output interfaces. For example, the output devices 770 may include the display device 104 of FIG. 1. The computing device 710 also contains one or more communication connections 780 that allow the computing device 710 to communicate with other computing devices 790 over a wired or a wireless network. In the embodiment illustrated, the computing device 710 may communicate with a policy database 792 and a report database 794. For example, the policy database 792 may be the policy database 106 of FIG. 1, and the report database 108 may be the report database 108 of FIG. 1.

It will be appreciated that not all of the components or devices illustrated in FIG. 7 or otherwise described in the previous paragraphs are necessary to support embodiments as herein described. For example, the removable storage 740 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-implemented method, comprising:
transmitting a configuration policy from a policy service to a managed computing device, wherein the configuration policy includes values of each of a plurality of configuration parameters and wherein the configuration policy identifies a subset of configuration parameters to be reported to the policy service; and
receiving report data at the policy service from the managed computing device, wherein the report data includes results of processing the configuration policy at the managed computing device.

2. The computer-implemented method of claim 1, further comprising:
receiving configuration metadata at the policy service; and
storing the configuration metadata at a policy database.

3. The computer-implemented method of claim 2, wherein the configuration metadata is received from a software developer.

4. The computer-implemented method of claim 2, wherein the configuration metadata includes a type of at least one configuration parameter, a constraint applicable to at least one configuration parameter, a description of at least one configuration parameter, a purpose of at least one configuration parameter, an applicability of at least one configuration parameter, or any combination thereof.

5. The computer-implemented method of claim 2, further comprising:
generating a configuration interface based on the configuration metadata, wherein the configuration interface is operable to receive the values of each of the plurality of configuration parameters;
receiving the values of each of the plurality of configuration parameters at the policy service via the configuration interface; and
storing the values at the policy database.

6. The computer-implemented method of claim 5, wherein the values are received from a system administrator.

7. The computer-implemented method of claim 1, wherein the report data includes the values of each of the plurality of configuration parameters from the configuration policy.

8. The computer-implemented method of claim 7, wherein the report data further includes second values of each of the subset of configuration parameters, wherein the second values are measured at the managed computing device.

9. The computer-implemented method of claim 1, further comprising storing the report data at a report database.

10. The computer-implemented method of claim 9, further comprising generating a configuration report that indicates a configuration status associated with one or more managed computing devices, wherein the configuration report is generated based on data retrieved from the report database.

11. The computer-implemented method of claim 1, wherein the policy service comprises a service that is accessible to the managed computing device via a private network or the Internet.

12. The computer-implemented method of claim 1, wherein the policy service is executed at one or more administration servers of a network that is accessible to the managed computing device.

13. A computer-readable medium comprising instructions that, when executed by a computer, cause the computer to:
receive a configuration policy from a policy service at a policy agent of a managed computing device, wherein the configuration policy includes values and constraints of each of a plurality of configuration parameters and wherein the configuration policy identifies a subset of the configuration parameters to be reported to the policy service;
process the configuration policy; and
transmit report data from the policy agent to the policy service, wherein the report data includes second values of each of the subset of configuration parameters, wherein the second values are determined at the managed computing device after processing the configuration policy.

14. The computer-readable medium of claim 13, wherein processing the configuration policy comprises evaluating the plurality of configuration parameters at the managed computing device for compliance with the configuration policy.

15. The computer-readable medium of claim 14, wherein processing the configuration policy further comprises:
determining that a particular value of a particular configuration parameter at the managed computing device is non-compliant with the configuration policy; and
updating the particular value of the particular configuration parameter to comply with the configuration policy.

16. The computer-readable medium of claim 13, wherein the configuration policy further includes a reporting schedule and wherein the report data is transmitted to the policy service in accordance with the reporting schedule.

17. The computer-readable medium of claim 13, wherein the configuration policy further includes a retrieval schedule and wherein the policy agent retrieves configuration policies from the policy service in accordance with the retrieval schedule.

18. The computer-readable medium of claim 13, wherein the configuration policy further includes a processing schedule and wherein the policy agent processes configuration policies in accordance with the processing schedule.

19. A computer system, comprising:
a processor; and
a policy service executable by the processor to:
receive configuration metadata including information associated with a plurality of configuration parameters;
generate an interface operable to receive desired values of the plurality of configuration parameters;
receive the desired values via the interface;
transmit a configuration policy to a plurality of managed computing devices, wherein the configuration policy includes the desired values and identifies a subset of configuration parameters to be reported to the policy service; and
receive report data from the plurality of managed computing devices, wherein the report data received from a particular managed computing device includes results of processing the configuration policy at the particular managed computing device.

20. The computer system of claim 19, further comprising a policy database, wherein the policy service is further executable by the processor to store the configuration metadata and the desired values at the policy database.
